(19) United States
(12) Patent Application Publication
(10) Pub. No.: US 2016/0131509 A1
(43) Pub. Date: May 12, 2016

(54) SYSTEM AND METHOD FOR SYNCHRONIZING CONSUMPTION DATA FROM CONSUMPTION METERS

(71) Applicant: ORACLE INTERNATIONAL CORPORATION, Redwood Shores, CA (US)

(72) Inventors: Lawrence NELSON, Kingwood, TX (US); Timothy MCAULIFFE, Middletown, CT (US); David SISKA, Oakland, CA (US)

(21) Appl. No.: 14/535,756

(22) Filed: Nov. 7, 2014

(51) Int. Cl. G01D 18/00; G01D 4/02

(52) U.S. Cl. CPC G01D 18/00; G01D 4/02

(57) ABSTRACT

Systems, methods, and other embodiments associated with synchronizing consumption data are described. In one embodiment, a method includes determining when a first consumption data of a first type and a second consumption data of a second type, derived from a same consumption meter, are unsynchronized with each other. The example method also includes synchronizing the first consumption data with the second consumption data when the two types of data are determined to be unsynchronized with each other.

### BACKGROUND

A consumption meter measures usage (i.e., consumption) over time of, for example, electricity, natural gas, or water by a customer of a utility provider.

Traditional interval consumption meters and newer “smart” consumption meters are minimally configured with two channels of consumption data being that of, for example, interval consumption data and register (scalar) consumption data. Having two sources of consumption data can cause many problems for utilities, however. For example, when the two types of consumption data are too dissimilar to each other in some way, the consumer may complain. These types of issues can drive up consumer support costs and possibly cause regulatory issues. Unfortunately, utilities often use both the register consumption data and the interval consumption data to satisfy their business requirements.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a solution flow showing how register consumption data and interval consumption data are loaded into a meter data management tool;

FIG. 2 illustrates one embodiment of a system, having a computing device, that is configured to provide synchronization of two types of consumption data derived from a same consumption meter by employing the meter data management tool of FIG. 1;

FIG. 3 illustrates one embodiment of a method, to reconcile register consumption data with interval consumption data, implemented to be performed by the meter data management tool of FIG. 1 and FIG. 2;

FIG. 4 illustrates one embodiment of a display view, provided by a graphical user interface of the meter data management tool of the system of FIG. 2, showing an example of interval consumption data received from the consumption meter of the system of FIG. 2;

FIGS. 5A and 5B illustrate one embodiment of display views, provided by a graphical user interface of the meter data management tool of the system of FIG. 2, showing an example of register consumption data received from the consumption meter of the system of FIG. 2;

FIG. 5C illustrates one embodiment of a display view, provided by a graphical user interface of the meter data management tool of the system of FIG. 2, indicating a time step for which synchronization of the interval consumption data of FIG. 4 and the register consumption data of FIGS. 5A and 5B is to be performed;

FIGS. 6A and 6B illustrate one embodiment of display views, provided by a graphical user interface of the meter data management tool of the system of FIG. 2, showing information with respect to re-estimating the interval consumption data based on the register consumption data;

FIG. 7 illustrates one embodiment of a display view, provided by a graphical user interface of the meter data management tool of the system of FIG. 2, showing synchronization of the register consumption data with the re-estimated interval consumption data; and

FIG. 8 illustrates one example embodiment of a computing device upon which an embodiment of a meter data management tool may be implemented.

### DETAILED DESCRIPTION

Systems and methods are described herein that provide synchronization (syncing) or reconciliation of two types (two channels) of consumption data (e.g., measurements) derived from a same consumption meter (e.g., a “smart” meter). The term “smart meter” as used herein generally refers to a device that records interval consumption events and register consumption events and supports two-way communication and commands (e.g., between the meter and a utility company system) such as: connect, disconnect, on-demand reading, etc. Such devices may also be configured to record other types of data including, for example, voltage and reactive power.

In one embodiment, a meter data management tool is disclosed that receives and reads a first type of consumption data (e.g., register data) from a consumption meter and a second type of consumption data (e.g., interval data) from the same consumption meter. The units of the consumption data may be, for example, watt-hours (Wh), liters, cubic feet (CF), or Joules for specific spans of time.

The first type of consumption data may be a singular scalar reading over a determined period of time (e.g., an hour or a day) and is called register consumption data or register data. The second type of consumption data may be made up of multiple readings over multiple time intervals (e.g., every 15 minutes) and is called interval consumption data or interval data. Both types of data may correspond to a same determined span of time, different spans of time, or may overlap in time to some extent. The register consumption data may be used for billing, and the interval consumption data may be used on a customer self-service portal, in accordance with one embodiment.

Data values associated with each type of data (e.g., total consumption values) may be different from each other for various reasons. For example, some meters use different technologies for recording interval and register readings and, therefore, the physical readings can be different. As another example, readings can vary because of different measurement times, or estimation processes can vary for each type of data and produce different results. Furthermore, there can be a different mix of actual and estimated measurements for each type of data, producing different results.

One or both types of consumption data may be pre-processed by the meter data management tool to, for example, fill in any gaps in the data or extrapolate the data over consumption time periods. For example, a singular scalar reading of register consumption data may be extrapolated over time periods spanning a half a day, corresponding to the time intervals of the interval consumption data from the same meter. Furthermore, any gaps (e.g., missed or corrupted measurements for certain time intervals) in the interval consumption data may be estimated and filled in to form a complete set of data over a determined time period. In this manner, the pre-processing ensures that the consumption data is in a form that can be used to synchronize both types of data with each other, if warranted.

In one embodiment, synchronizing the data refers to the meter data management tool adjusting (e.g., converting, transforming, modifying, changing, amending, or adapting) one or both types of data such that a total consumption value (e.g., in kilowatt-hours) for the first type of consumption data matches a total consumption value for the second type of consumption data over a same determined period of time. When both total consumption values are matched, this means that they are within some acceptable tolerance of each other (e.g., within 0.01 kilowatt-hours), or are exactly the same (e.g., 24.03 kilowatt-hours).

As a simple example, if the interval consumption data comprises usage of 1 kWh for every hour over a 24-hour period of time, then the corresponding total consumption value is 24 kWh over that 24-hour period of time. By synchronizing both types of data with each other in this manner with respect to total consumption over a determined period of time, a customer or a regulatory agency may be less likely to question or express concern about the validity of the data.

In one embodiment, certain functionality is provided. For example, automatic syncing of measurements may be performed based on updates to a related channel of data. Also, estimated register readings may be refreshed when a new non-estimated reading is received. Furthermore, primary and secondary channels of data may be user-defined and automatic ordering of pending readings may be performed to ensure that primary channel measurements are processed first. However, out-of-order processes may be provided which allow consumption syncing to execute even if the primary measurements are processed after secondary measurements.

Also, in accordance with one embodiment, unwanted syncing of data may be prevented when the consumption difference between two data channels is within a user defined tolerance. In addition, different types of rules may be applied for different types of consumption data (e.g., normal, estimated, manually entered). Furthermore, one-to-many reading scenarios may be accommodated (e.g., four interval readings per day and one register reading per day, or vice versa). Syncing may still occur even if the readings from related channels end at different times (e.g., the register reading ends at 12:05 AM and the interval readings end at midnight). Existing scalar estimates may be prorated based on subsequent actual readings, and rules to prevent unwanted overwriting of measurements may be provided.

Example embodiments are discussed herein with respect to consumption meters providing two sources of consumption data including register consumption data and interval consumption data. Other types of consumption data are possible as well, in accordance with other embodiments. Also, other embodiments may be configured to reconcile (synchronize) more than two types of consumption data. Furthermore, other embodiments may be implemented as part of any computer application for managing metered data.

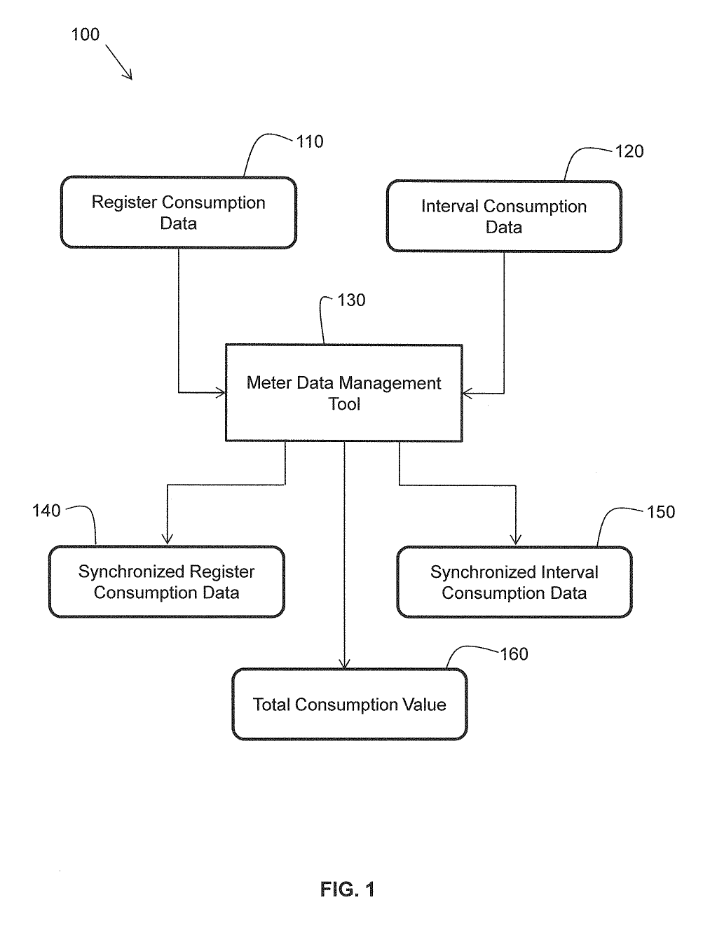

FIG. 1 illustrates one embodiment of a solution flow 100 showing how register consumption data 110 and interval consumption data 120 from a consumption meter are loaded into a meter data management tool 130. The meter data management tool 130 is configured to synchronize the register consumption data 110 with the interval consumption data 120, when warranted, resulting in synchronized register consumption data 140 and synchronized interval consumption data 150. In one embodiment, the register consumption data 110 and the interval consumption data 120 are considered to be synchronized with each other when total consumption values 160 for each, over a same determined period of time, are determined to be the same or within some determined tolerance value of each other.

In one embodiment, the register consumption data 110 and the interval consumption data 120 originate from the same source (e.g., a consumption meter). The register consumption data 110 may be a singular scalar reading over a determined period of time (e.g., 12 hours or 24 hours). The interval consumption data 120 may be made up of multiple readings over multiple time intervals (e.g., every 30 minutes over a 24 hour period). Both types of consumption data may correspond to a same determined span of time, different spans of time, or may overlap in time to some extent.

The units of the consumption data may be, for example, kilowatt-hours (kWh), gallons, one hundred cubic feet (CCF), or British Thermal Units (BTU) for specific spans of time, depending on the type of utility and associated meter configuration. For example, in one embodiment, interval consumption data from an electric consumption meter may comprise twenty-four (24) values in units of kilowatt-hours (kWh) and twenty-four (24) associated values in units of time-of-day. In this manner, a complete hourly profile of electricity usage for a consumer associated with the electric consumption meter can be captured.

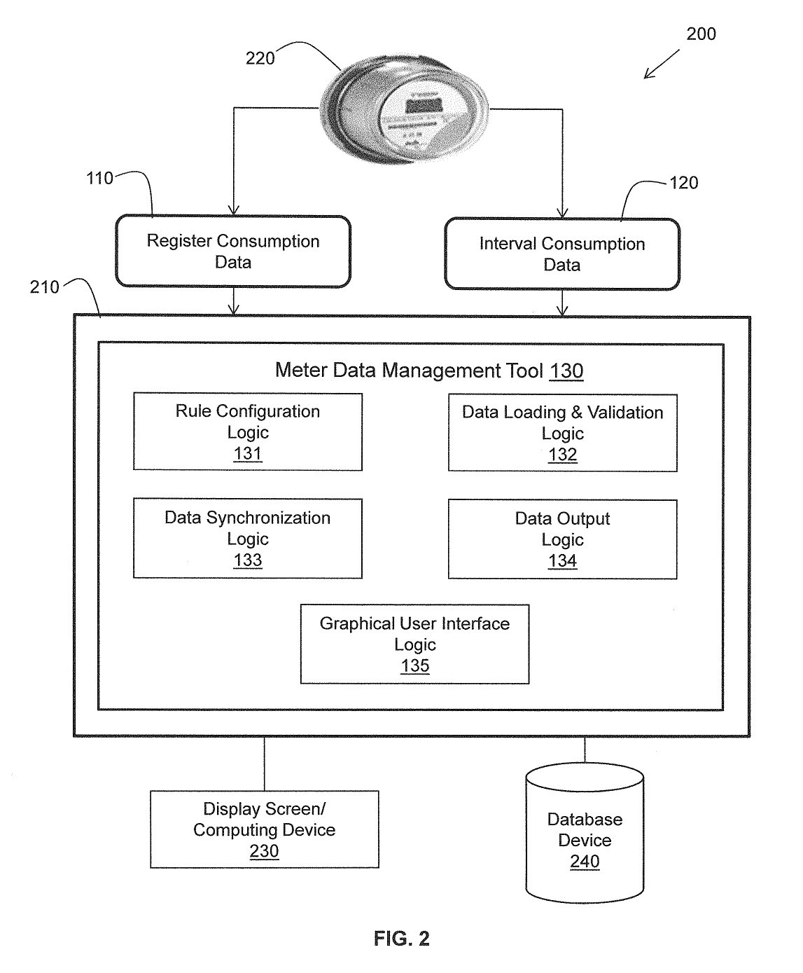

FIG. 2 illustrates one embodiment of a system 200 having a computing device 210 that is configured to provide synchronization of two types of consumption data (e.g., register consumption data and interval consumption data) derived from a same consumption meter 220 by employing the meter data management tool 130 of FIG. 1. For example, in accordance with one embodiment, a meter data management tool 130 may provide data to a customer service computer application of a utility company, configured for providing a portal for customers to view their consumption history, utility rates, bills, etc. A graphical user interface is provided by graphical user interface logic of the customer service computer application. The software and computing device 210 may be configured to operate with or be implemented as a cloud-based networking system, a software-as-a-service (SaaS) architecture, or other type of computing solution.

In another embodiment, the application may be used by an enterprise organization and include functionality to facilitate the loading, validation, estimation, and editing of measurements associated with consumption meters. Consumption data is the cornerstone of any energy enterprise, affecting billing, settlement, load research, pricing, forecasting, and revenue management. Consumption data should be virtually error free, or each subsequent business function may be adversely affected.

With reference to FIG. 2, in one embodiment, the meter data management tool 130 is implemented on the computing device 210 and includes a plurality of logics for implementing various functional aspects of the meter data management tool 130. For example, in one embodiment, the meter data management tool 130 includes rule configuration logic 131, data loading and validation logic 132, data synchronization logic 133, data output logic 134, and graphical user interface (GUI) logic 135. However, other embodiments may provide different logics or combinations of logics that provide the same or similar functionality as the meter data management tool 130 of FIG. 2.

In one embodiment, the meter data management tool 130 is an executable application including algorithms and/or program modules configured to perform the functions of the logics. The application is stored in a non-transitory medium. In another embodiment, the data loading and validation logic 132 and the data synchronization logic 133 are combined into a single logic.

The computer system 200 also includes a display screen 230 operably connected to the computing device 210. In accordance with one embodiment, the display screen 230 is used to display views of a graphical user interface (GUI) provided by the GUI logic 135 for meter data management. In one embodiment, the meter data management tool 130 is a centralized server-side application that is accessed by many users. Thus, the display screen 230 may represent multiple computing devices/terminals that allow users to access and receive services from the meter data management tool 130 via network communications.

The computer system 200 further includes at least one database device 240 operably connected to the computing device 210 or a network interface to access the database device 240 via a network connection. In accordance with one embodiment, the database device 240 is configured to store and manage data structures associated with the meter data management tool 130 (e.g., an enterprise management computer application) in a database system.

Referring back to the logics of the meter data management tool 130 of FIG. 2, in one embodiment, the GUI logic 135 is configured to at least provide a graphical user interface. For example, the GUI logic 135 includes program code that generates and causes the graphical user interface to be displayed based on implemented graphical design of the interface. The GUI logic 135 is also configured to facilitate the opening of data structures (e.g., files or records) associated with the meter data management tool 130 (e.g., a customer service computer application) on a display screen in response to user interaction with the graphical user interface. For example, in response to user actions and selections via the GUI, associated data structures may be generated, accessed, viewed, edited, or otherwise manipulated via the database device.

As an example, the graphical user interface provided by the GUI logic 135 is configured to allow a user (e.g., an employee of a utility company) to create, access, open, view, edit, and delete records stored in the database device 240. Various examples of the interface will be discussed in the following figures.

In one embodiment, the rule configuration logic 131 is configured to facilitate user generation and editing, via the graphical user interface, of rules to be applied by the data synchronization logic 133 and the data loading and validation logic 132. Such rules may include, for example, rules associated with defining the priority of consumption data, rules associated with loading consumption data, rules associated with estimating consumption data, rules associated with extrapolating consumption data, and rules associated with synchronizing consumption data. For example, the various rules may define which functionality to perform or which thresholds to apply based on the current circumstances. The rules may be based on, for example, regulatory requirements, internal requirements, or the type of consumption meter.

In one embodiment, data loading and validation logic 132 is configured to read at least one data structure comprising primary consumption data (e.g., register consumption data) and secondary consumption data (e.g., interval consumption data) derived from a same consumption meter 220. The data may be derived from the consumption meter 220 via, for example, computer communication between the consumption meter and the computing device 210.

One or more of the rules defined in rule configuration logic 131 may be applied by logic 132 to determine when the register consumption data is primary and when the interval consumption data is primary. Once one type of consumption data is defined as being primary, the other remaining type of consumption data is, by default, defined as being secondary.

Register consumption data is often defined as being primary because register consumption data from many consumption meters tends to be more reliable. However, with the advent of newer meter technologies, interval consumption data may be just as reliable, if not more reliable, than register consumption data for some meters. Other criteria or rules for defining which consumption data is primary and which consumption data is secondary are possible as well, in accordance with other embodiments. For example, for some meters, interval consumption data may be selected to be primary because more regular and reliable updates of interval consumption data are received by the meter data management tool 130 than register consumption data.

Logic 132 is also configured to pre-process, when warranted, at least one of the primary consumption data and the secondary consumption data to put the data in a form that is compatible with a data synchronization process. For example, in one embodiment, logic 132 may pre-process interval consumption data to fill in identified gaps. Identified gaps in the data may be due to, for example, missed measurements at the meter, or faulty transmission of the data from the meter to the meter data management tool. In situations where the associated register consumption data is primary (e.g., more reliable) and is available, gaps in the interval consumption data may be filled in by logic 132 by applying predetermined rules from logic 131 to the register consumption data.

For example, if the register consumption data is a single measurement, the register consumption data may be extrapolated over time periods (defined by the interval consumption data) by logic 132 as part of pre-processing. Certain time periods of the extrapolated register consumption data may then be used to fill in the gaps in the interval consumption data. In one embodiment, extrapolation of the register consumption data may result in an even distribution over the time periods. In another embodiment, extrapolation of the register consumption data may be performed in accordance with a determined profile, resulting in an uneven or non-linear distribution over the time periods.

Interval gaps may be filled in various ways. For example, estimation can be performed with standard rules relating to the interval data, from a related scalar channel, or from combinations of both methods. Conversely, register gaps can be filled in a similar manner. When the associated register consumption data is not available, gaps in the interval consumption data may be filled in by various estimation methods using only the interval consumption data, for example. In one embodiment, pre-processing is performed before determining when register consumption data is unsynchronized with interval consumption data.

Logic 132 is also configured to determine when the primary consumption data and the secondary consumption data are unsynchronized with each other. For example, in one embodiment, logic 132 is configured to determine that the primary consumption data and the secondary consumption data are unsynchronized with each other when a calculated difference between a total consumption value of the primary consumption data and a total consumption value of the secondary consumption data, over a same period of time, is greater than a determined threshold. When two types of data are determined to be unsynchronized with each other, a synchronization process may be initiated by data synchronization logic 133.

Data synchronization logic 133 is configured to synchronize the primary consumption data (e.g., register consumption data) with the secondary consumption data (e.g., interval consumption data) by performing the data synchronization process. The data synchronization logic 133 is configured to achieve synchronization by matching total consumption values.

In one embodiment, logic 133 is configured to adjust (e.g., convert, transform, modify, change, amend, or adapt) at least one of the primary consumption data and the secondary consumption data. The data are changed to match a total consumption value of the primary consumption data with a total consumption value of the secondary consumption data over a same determined period of time. In one embodiment, the pre-processing functionality described herein is part of the data synchronization logic 133.

For example, in one embodiment, logic 133 is configured to extrapolate the primary consumption data across multiple consumption time periods associated with the secondary consumption data. Logic 133 then adjusts the secondary consumption data, for at least one consumption time period of the multiple time periods, based on the extrapolated primary consumption data. The secondary consumption data is adjusted such that a total consumption value of the adjusted secondary consumption data (e.g., synchronized interval consumption data 150) matches a total consumption value of the extrapolated primary consumption data (e.g., synchronized register consumption data 140) over a determined time period. In one embodiment, synchronizing includes transforming one of the primary consumption data and the secondary consumption data. In another embodiment, synchronizing includes transforming both of the primary consumption data and the secondary consumption data. Other methods of primary and secondary data synchronization are possible as well, in accordance with other embodiments.

In one embodiment, data output logic 134 is configured to output the synchronized primary consumption data (e.g., synchronized register consumption data 140) and synchronized secondary consumption data (e.g., synchronized interval consumption data 150) to one or more data structures of the database device 240. The one or more data structures may include, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

In one embodiment, the synchronized consumption data in the database device 240 may be accessed and viewed by a customer associated with the consumption meter 220 from which the consumption data was derived to view their history of consumption. In accordance with another embodiment, the synchronized consumption data in the database device 240 may be accessed and used by other portions of the meter data management tool 130, or by other applications, for purposes of billing, settlement, load research, pricing, forecasting, and revenue management for a utility company, for example.

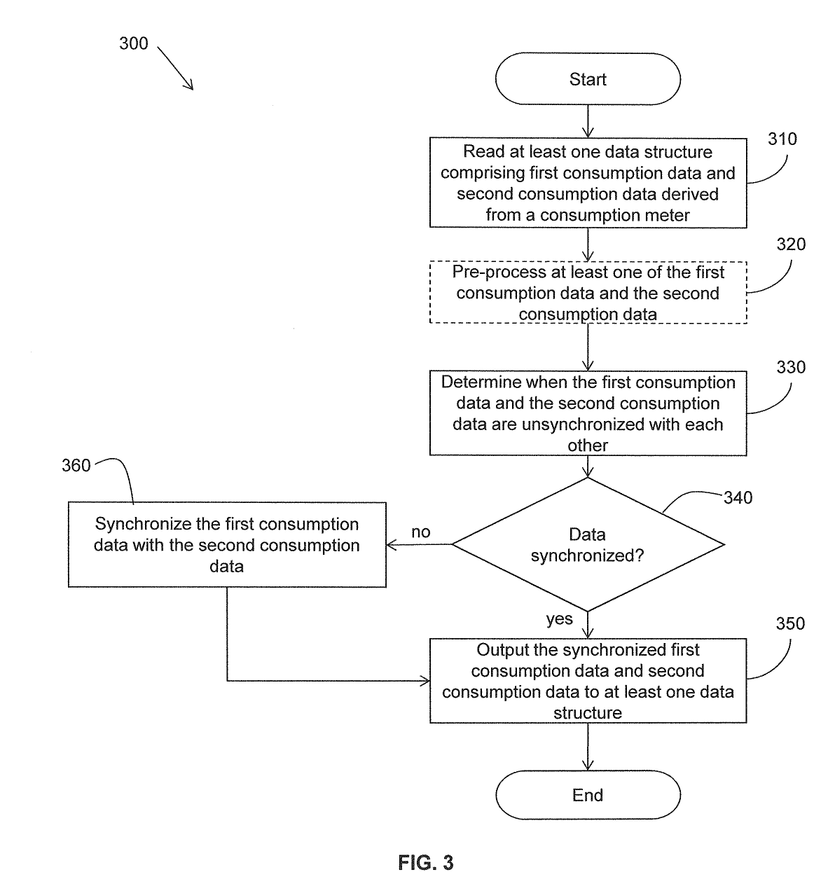

FIG. 3 illustrates one embodiment of a method 300 to reconcile register consumption data with interval consumption data. Method 300 is implemented to be performed by the meter data management tool 130 of FIG. 1 and FIG. 2, or by a computing device configured with an algorithm of method 300. Method 300 will be described from the perspective that inputs to the meter data management tool 130 (e.g., first consumption data and second consumption data) have already been measured and input to the tool 130, and that rules have already been generated via the rule configuration logic 131 within the tool 130.

Upon initiating method 300, at block 310, at least one data structure is read comprising first consumption data (e.g., register consumption data 110) and second consumption data (e.g., interval consumption data 120) derived from a consumption meter 220. The first consumption data and the second consumption data from the meter 220 may be complete and error free, or may be incomplete (have gaps) and may possibly be corrupted in some way (have errors).

Optionally, at block 320, at least one of the first consumption data and the second consumption data may be pre-processed. For example, if there are gaps in the data, the gaps may need to be filled in as described above herein with respect to the pre-processing functionality of the data loading and validation logic 132. Furthermore, if any of the data is known or determined to be corrupted, that corrupted data may be discarded, creating a gap in the data. The gap may be filled by the data loading and validation logic 132 using techniques described herein (e.g., data extrapolation and data interpolation).

As another example of pre-processing, if the first consumption data is in a different form or units than the second consumption data, pre-processing may be performed to put both types of data in the same form or units. For example, in one embodiment, if the first consumption data is in units of kilowatt-hours (kWh) and the second consumption data is in units of kilojoules (KJ), the second consumption data may be converted to units of kilowatt-hours (kWh) as part of pre-processing by logic 132.

In many instances, pre-processing of the data may be unwarranted and the method 300 proceeds from block 310 directly to block 330. At block 330, a determination is made as to whether or not the first consumption data and the second consumption data are unsynchronized with each other. The data are unsynchronized with each other when a total consumption value of the first consumption data does not match a total consumption value of the second consumption data over a same determined period of time. For example, in one embodiment, the data are unsynchronized with each other when a difference between a total consumption value of the first consumption data and a total consumption value of the second consumption data, over a same determined period of time, is greater than a determined threshold value.

For interval consumption data, the total consumption data may be determined simply by adding the kWh values for each consumption time interval over the determined period of time. For the register consumption data, the total consumption data may simply be the single scalar register value received as the register consumption data. In one embodiment, a SUM-CHECK is performed which includes adding the kWh (or other unit) values for each consumption time interval over the determined period of time and comparing (checking) the sum against the single scalar register value in kWh (or other units).

At block 340, a decision is made. If the first consumption data is synchronized with the second consumption data, as determined at block 330, then method 300 proceeds to block 350. At block 350, the synchronized first and second consumption data are output to at least one data structure. For example, in one embodiment, the synchronized first consumption data (e.g. synchronized register consumption data 140) is output to a first data structure of the database device 240. The synchronized second consumption data (e.g., synchronized interval consumption data 150) is output to a second data structure of the database device 240.

At block 340, if the first consumption data is not synchronized with the second consumption data as determined at block 330, then the method 300 proceeds to block 360. At block 360, the first consumption data is synchronized with the second consumption data by data synchronization logic 133. In accordance with one embodiment, synchronizing the data comprises adjusting at least one of the first consumption data or the second consumption data to match a total consumption value of the first consumption data with a total consumption value of the second consumption data over a determined period of time. When both total consumption values are matched, this means that they are within some acceptable tolerance of each other (e.g., within 0.03 kilowatt-hours), or are exactly the same (e.g., 51.06 kilowatt-hours).

Some or all of one or the other type of data may be adjusted, in accordance with various embodiments. In embodiments where the register consumption data is primary, the register consumption data may be used to adjust one or more time periods of the secondary interval consumption data. This may be the case when the interval consumption data for a consumption time period is considered to be corrupted. The corrupted interval consumption data for that consumption time period may be discarded. Extrapolated register consumption data corresponding to the bordering consumption time periods may be used to replace the corrupted interval consumption data via interpolation and scaling (or some other technique) to synchronize the two types of data with respect to total consumption values.

In accordance with another embodiment, the second consumption data is distributed over multiple consumption time intervals (e.g., every hour of a 24-hour day). Synchronizing the data comprises adjusting the interval consumption data for each consumption time interval of the multiple consumption time intervals to make a total consumption value of the second consumption data match a total consumption value of the first consumption data over a determined period of time (e.g., 12 hours of the 24-hour day). Other specific ways of synchronizing two types of consumption data with respect to total consumption values are possible as well, in accordance with other embodiments.

Once the data are synchronized, at block 350, the synchronized first and second consumption data are output to at least one data structure (e.g., at least one data structure of database device 240). Again, the synchronized consumption data in the database device 240 may be accessed and viewed by a customer associated with the consumption meter 220 from which the consumption data was derived to view their history of consumption. In accordance with another embodiment, the synchronized consumption data in the database device 240 may be accessed and used by other portions of the meter data management tool 130, or by other applications, for purposes of billing, settlement, load research, pricing, forecasting, and revenue management.

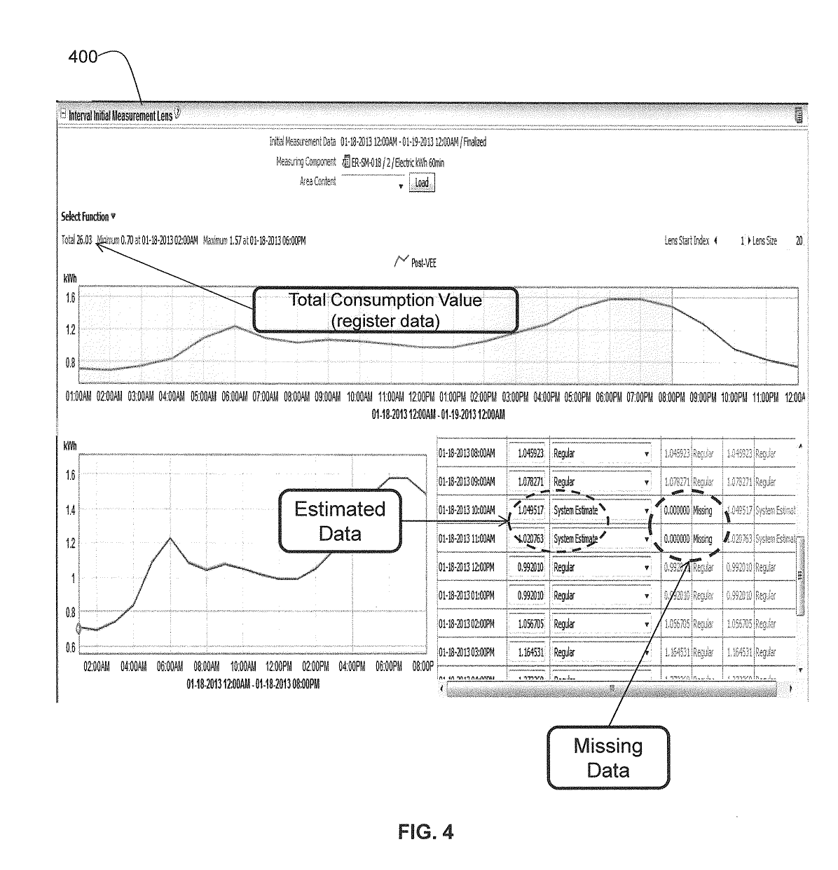

FIGS. 4-7 herein illustrate an example embodiment of a method of synchronizing first and second consumption data from a consumption meter. Display views, provided by a graphical user interface of the meter data management tool 130 of the system 200, are presented to illustrate the example embodiment. In the example embodiment of FIGS. 4-7, secondary interval consumption data 120 is received and loaded at the tool 130 before primary register consumption data 110. Synchronization of the data does not proceed until the primary register consumption data is received and loaded.

FIG. 4 illustrates one embodiment of a display view 400, provided by a graphical user interface of the meter data management tool 130 of the system 200 of FIG. 2. In particular, FIG. 4 shows an example of interval consumption data 120 received from the consumption meter 220 of the system 200 of FIG. 2. Referring to FIG. 4, the interval consumption data has a total consumption value of 26.03 kWh. Each consumption time period of the interval consumption data includes legitimate actual data from the consumption meter 220 except for two of the intervals where the data is missing.

In one embodiment, if the corresponding register consumption data was available, it would be used to estimate the missing data in the interval consumption data, since the register consumption data is primary (e.g., more reliable). However, since the register consumption data is not yet available, the missing data for the two consumption time periods is estimated, at least temporarily, based on a portion of the interval consumption data that is not missing (e.g., using interpolation). The total consumption value of 26.03 kWh for the interval consumption data is based on such a temporary estimate.

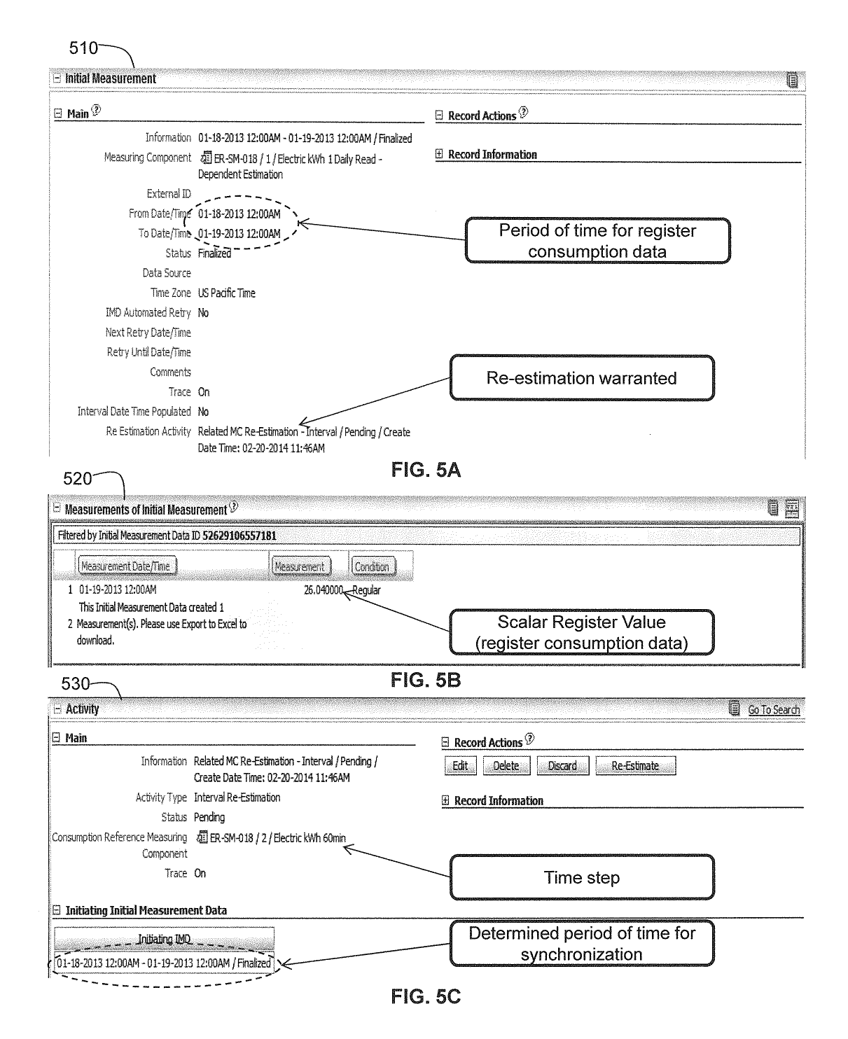

FIGS. 5A and 5B illustrate one embodiment of display views 510 and 520, respectively, provided by a graphical user interface of the meter data management tool 130 of the system 200 of FIG. 2. FIGS. 5A and 5B show an example of register consumption data 110 received from the consumption meter 220 of the system 200 of FIG. 2. The register consumption data comprises a scalar value of 26.04 kWh, which is greater than the total consumption value of 26.03 kWh for the interval consumption data.

In accordance with one or more rules of the rule configuration logic 131, since the register consumption data is primary and the secondary interval consumption data was received before the primary consumption data, the data synchronization logic 133 checks for any estimated interval consumption data measurements that fall within the time period of the register read. Given that there are two estimated intervals, as detailed above, re-estimation of those two intervals is warranted and will be performed based on the register consumption data.

FIG. 5C illustrates one embodiment of a display view 530, provided by a graphical user interface of the meter data management tool 130 of the system 200 of FIG. 2. The display view 530 indicates a time step for which synchronization of the interval consumption data of FIG. 4 and the register consumption data of FIGS. 5A and 5B is to be performed. In this example, the time step is 60 minutes and the determined period of time is from 12:00 a.m. on Jan. 18, 2013 to 12:00 a.m. on Jan. 19, 2013 (i.e., a 24 hour period).

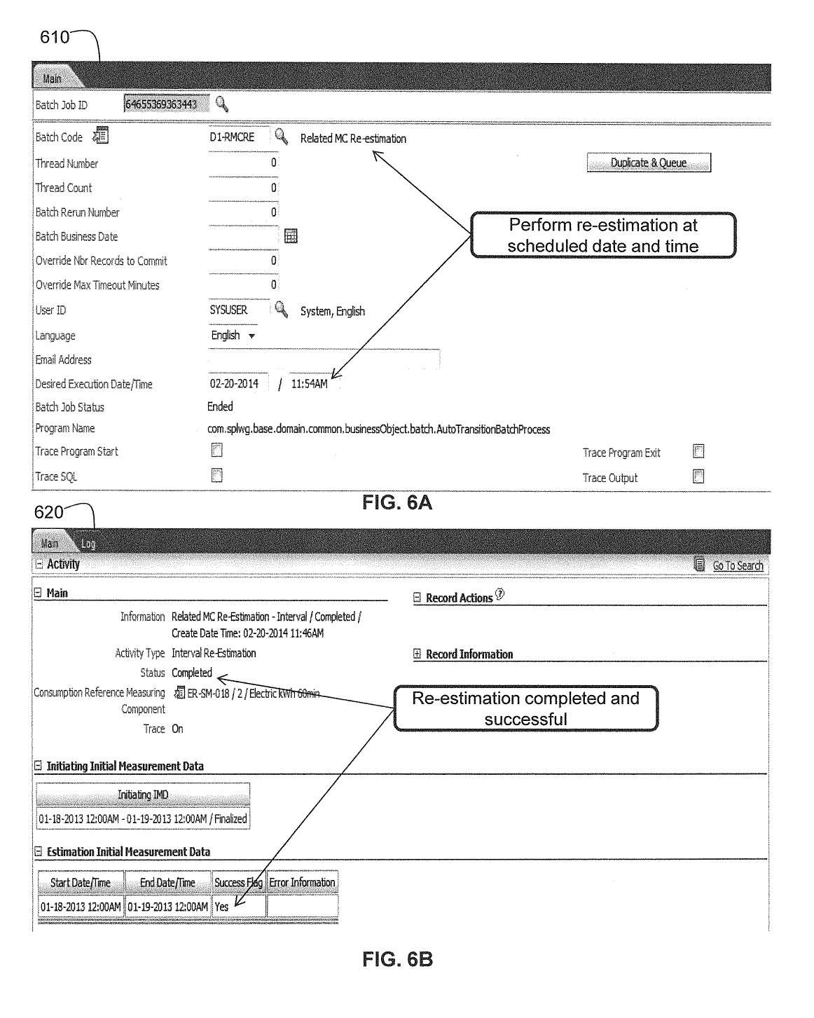

FIGS. 6A and 6B illustrate one embodiment of display views 610 and 620, respectively, provided by a graphical user interface of the meter data management tool 130 of the system 200 of FIG. 2. FIGS. 6A and 6B show information with respect to re-estimating the interval consumption data based on the register consumption data. FIG. 6A indicates that re-estimation is scheduled to be performed on Feb. 20, 2014 at 11:54 a.m. FIG. 6B indicates that re-estimation was performed at the scheduled time, was completed, and was successful.

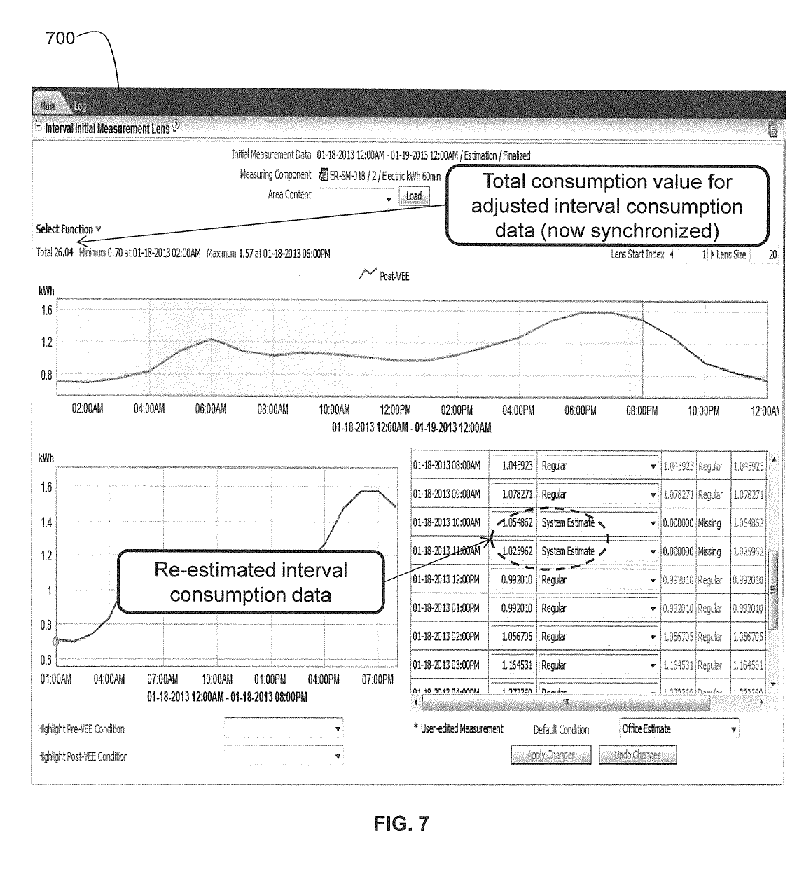

FIG. 7 illustrates one embodiment of a display view 700, provided by a graphical user interface of the meter data management tool 130 of the system 200 of FIG. 2. FIG. 7 shows synchronization of the register consumption data with the re-estimated interval consumption data. Synchronization was performed for the determined period of time which, in this instance, was equivalent to the 24-hour period for which the scalar register consumption data was provided.

The total consumption value of the interval consumption data is now 26.04 kWh and matches the total consumption value for the register consumption data. The two intervals that were missing for the interval consumption data have been estimated once more (re-estimated) based on the benefit of having the register consumption data available. In this example, the scalar register consumption data value of 26.04 kWh was extrapolated over the 24-hour determined period of time. Interpolation and scaling was performed on the extrapolated register consumption data to re-estimate the interval consumption data for the two missing consumption time periods such that synchronization with respect to total consumption was achieved.

In accordance with one embodiment, the data loading and validation logic 132 performed the initial estimation of missing interval consumption data and the extrapolation of the register consumption data. The data synchronization logic 133 performed the synchronization of the register consumption data and the interval consumption data by re-estimating the missing interval consumption data based on interpolation and scaling techniques.

In this manner, even though a second consumption data is not available until after a first consumption data is available, an initial estimate of any missing first consumption data and the resulting total consumption value over a determined period of time can be determined. Once the corresponding second consumption data becomes available, both first and second consumption data can be pre-processed and synchronized based on which consumption data is considered primary and which is considered secondary (e.g., based on rules provided by the rule configuration logic 131).

### Computing Device Embodiment

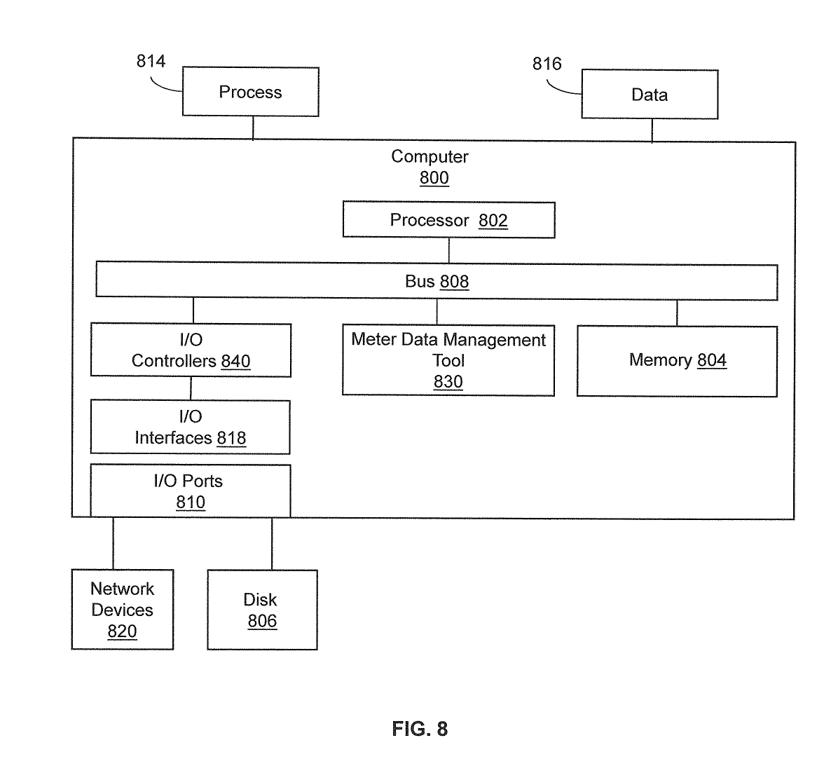

FIG. 8 illustrates an example computing device that is configured and/or programmed with one or more of the example systems and methods described herein, and/or equivalents. FIG. 8 illustrates one example embodiment of a computing device upon which an embodiment of a meter data management tool may be implemented. The example computing device may be a computer 800 that includes a processor 802, a memory 804, and input/output ports 810 operably connected by a bus 808. In one example, the computer 800 may include meter data management tool 830 configured to facilitate synchronizing of two types of consumption data similar to meter data management system 130 shown in FIG. 1 and FIG. 2. In different examples, the tool 830 may be implemented in hardware, a non-transitory computer-readable medium with stored instructions, firmware, and/or combinations thereof. While the tool 830 is illustrated as a hardware component attached to the bus 808, it is to be appreciated that in other embodiments, the tool 830 could be implemented in the processor 802, stored in memory 804, or stored in disk 806.

In one embodiment, tool 830 or the computer 800 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate synchronizing of two types of consumption data. The means may also be implemented as stored computer executable instructions that are presented to computer 800 as data 816 that are temporarily stored in memory 804 and then executed by processor 802.

Tool 830 may also provide means (e.g., hardware, non-transitory computer-readable medium that stores executable instructions, firmware) for performing synchronization of two types of consumption data.

Generally describing an example configuration of the computer 800, the processor 802 may be a variety of various processors including dual microprocessor and other multi-processor architectures. A memory 804 may include volatile memory and/or non-volatile memory. Non-volatile memory may include, for example, ROM, PROM, and so on. Volatile memory may include, for example, RAM, SRAM, DRAM, and so on.

A storage disk 806 may be operably connected to the computer 800 via, for example, an input/output interface (e.g., card, device) 818 and an input/output port 810. The disk 806 may be, for example, a magnetic disk drive, a solid state disk drive, a floppy disk drive, a tape drive, a Zip drive, a flash memory card, a memory stick, and so on. Furthermore, the disk 806 may be a

CD-ROM drive, a CD-R drive, a CD-RW drive, a DVD ROM, and so on. The memory 804 can store a process 814 and/or a data 816, for example. The disk 806 and/or the memory 804 can store an operating system that controls and allocates resources of the computer 800.

The computer 800 may interact with input/output devices via the i/o interfaces 818 and the input/output ports 810. Input/output devices may be, for example, a keyboard, a microphone, a pointing and selection device, cameras, video cards, displays, the disk 806, the network devices 820, and so on. The input/output ports 810 may include, for example, serial ports, parallel ports, and USB ports.

The computer 800 can operate in a network environment and thus may be connected to the network devices 820 via the i/o interfaces 818, and/or the i/o ports 810. Through the network devices 820, the computer 800 may interact with a network. Through the network, the computer 800 may be logically connected to remote computers. Networks with which the computer 800 may interact include, but are not limited to, a LAN, a WAN, and other networks.

Systems and methods have been described herein that provide synchronization of two types (two channels) of consumption data derived from a same consumption meter (e.g., a “smart” meter). By synchronizing both types of data with each other with respect to, for example, total consumption over a determined period of time, a customer or a regulatory agency may be less likely to question or express concern about the validity of the consumption data.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer communication”, as used herein, refers to a communication between computing devices (e.g., computer, personal digital assistant, cellular telephone) and can be, for example, a network transfer, a file transfer, an applet transfer, an email, an HTTP transfer, and so on. A computer communication can occur across, for example, a wireless system (e.g., IEEE 802.11), an Ethernet system (e.g., IEEE 802.3), a token ring system (e.g., IEEE 802.5), a LAN, a WAN, a point-to-point system, a circuit switching system, a packet switching system, and so on.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C §101.

“Logic”, as used herein, represents a component that is implemented with computer or electrical hardware, firmware, a non-transitory medium with stored instructions of an executable application or program module, and/or combinations of these to perform any of the functions or actions as disclosed herein, and/or to cause a function or action from another logic, method, and/or system to be performed as disclosed herein. Logic may include a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. Logic is limited to statutory subject matter under 35 U.S.C. §101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method comprising:
reading, by a meter data management tool, at least one data structure comprising first consumption data and second consumption data derived from a consumption meter;
determining, by the meter data management tool, when the first consumption data and the second consumption data are unsynchronized with each other;
synchronizing, by the meter data management tool, the first consumption data with the second consumption data when the determining indicates that the first consumption data and the second consumption data are unsynchronized with each other; and
outputting, by the meter data management tool, synchronized first consumption data and synchronized second consumption data to at least one data structure.

2. The computer-implemented method of claim 1, wherein the first consumption data and the second consumption data are unsynchronized with each other when a difference between a total consumption value of the first consumption data and a total consumption value of the second consumption data, over a same determined period of time, is greater than a determined threshold value.

3. The computer-implemented method of claim 1, wherein the synchronizing comprises adjusting at least one of the first consumption data and the second consumption data to match a total consumption value of the first consumption data with a total consumption value of the second consumption data over a determined period of time.

4. The computer-implemented method of claim 1, wherein the first consumption data comprises register consumption data, and the second consumption data comprises interval consumption data distributed over a plurality of consumption time intervals.

5. The computer-implemented method of claim 1, further comprising identifying and filling in gaps in the second consumption data, by the meter data management tool, based at least in part on interpolating the second consumption data.

6. The computer-implemented method of claim 1, further comprising identifying and filling in gaps in the second consumption data, by the meter data management tool, by applying a set of predetermined rules to the second consumption data based, at least in part, on the first consumption data.

7. The computer-implemented method of claim 1, wherein the second consumption data comprises interval consumption data distributed over a plurality of consumption time intervals, and wherein the synchronizing comprises adjusting the interval consumption data for each consumption time interval of the plurality of consumption time intervals to make a total consumption value of the second consumption data match a total consumption value of the first consumption data over a determined period of time.

8. The computer-implemented method of claim 1, further comprising evenly extrapolating, by the meter data management tool, the first consumption data across a plurality of consumption time periods associated with the second consumption data.

9. The computer-implemented method of claim 1, further comprising unevenly extrapolating, by the meter data management tool, the first consumption data across a plurality of consumption time periods associated with the second consumption data based on at least a determined profile.

10. The computer-implemented method of claim 1, further comprising billing a customer associated with the consumption meter based, at least in part, on a total consumption value of at least one of the synchronized first consumption data and the synchronized second consumption data.

11. A computing system, comprising:
data loading and validation logic configured to:
(i) read at least one data structure comprising primary consumption data and secondary consumption data derived from a same consumption meter,
(ii) pre-process at least one of the primary consumption data and the secondary consumption data to put in a form that is compatible with a data synchronization process, and
(iii) determine when the primary consumption data and the secondary consumption data are unsynchronized with each other;
data synchronization logic configured to synchronize the primary consumption data with the secondary consumption data by performing the data synchronization process; and
data output logic configured to output the synchronized primary consumption data and secondary consumption data to at least one data structure of a database device.

12. The computing system of claim 11, further comprising rule configuration logic configured to facilitate user generation of rules to be applied by at least the data synchronization logic and the data loading and validation logic.

13. The computing system of claim 11, wherein the synchronization logic is configured to adjust at least one of the primary consumption data and the secondary consumption data to match a total consumption value of the primary consumption data with a total consumption value of the secondary consumption data over a determined period of time.

14. The computing system of claim 11, wherein the synchronization logic is configured to synchronize the primary consumption data with the secondary consumption data by:
(i) extrapolating the primary consumption data across a plurality of consumption time periods associated with the secondary consumption data, and
(ii) adjusting the secondary consumption data, for at least one consumption time period of the plurality of consumption time periods, based on, at least in part, the extrapolated primary consumption data such that a total consumption value of the adjusted secondary consumption data matches a total consumption value of the extrapolated primary consumption data over a determined period of time.

15. The computing system of claim 11, wherein the primary consumption data comprises register consumption data, and the secondary consumption data comprises interval consumption data distributed over a plurality of consumption time intervals.

16. A non-transitory computer-readable medium storing computer-executable instructions that are part of an algorithm that, when executed by a computer, cause the computer to perform a method, wherein the instructions comprise instructions configured for:
reading at least one data structure comprising register data and interval data derived from a consumption meter;
determining when the register data and the interval data are unsynchronized with each other; and
synchronizing the register data with the interval data, when the register data and the interval data are determined to be unsynchronized with each other, by performing a data synchronization process that matches a total consumption value of the interval data with a total consumption value of the register data.

17. The non-transitory computer-readable medium of claim 16, wherein the instructions further comprise instructions configured for outputting the synchronized register data and interval data to at least one data structure of a database device.

18. The non-transitory computer-readable medium of claim 16, wherein the instructions for determining comprise instructions configured for calculating a difference between the total consumption value of the register data and the total consumption value of the interval data, over a same determined time period, that is greater than a determined threshold value.

19. The non-transitory computer-readable medium of claim 16, wherein the instructions for synchronizing comprise instructions configured for adjusting the interval data until a difference between the total consumption value of the register data and the total consumption value of the interval data, over a same determined time period, is less than a determined threshold value.

20. The non-transitory computer-readable medium of claim 16, wherein the instructions further comprise instructions configured for pre-processing at least one of the register data and the interval data, before determining when the register data and the interval data are unsynchronized, to put at least one of the register data and the interval data in a form that is compatible with the data synchronization process.
